(19) United States
(12) Patent Application Publication
(10) Pub. No.: US 2015/0286623 A1
(43) Pub. Date: Oct. 8, 2015

(54) METHOD AND APPARATUS FOR MARKING RELEVANT UPDATES TO HTML 5

(71) Applicant: Samsung Electronics Co., Ltd., Suwon-si (KR)

(72) Inventors: Imed Bouazizi, Plano, TX (US); Youngkwon Lim, Allen, TX (US)

(21) Appl. No.: 14/616,972

(22) Filed: Feb. 9, 2015

Related U.S. Application Data
(60) Provisional application No. 61/974,245, filed on Apr. 2, 2014.

(51) Int. Cl. G06F 17/24; G06F 17/27; G06F 17/30; G06F 17/22

(52) U.S. Cl. CPC G06F 17/241; G06F 17/2247; G06F 17/2705; G06F 17/30011; G06F 17/30345

(57) ABSTRACT

A method for annotating instructions of Composition Information (CI) files to update a hypertext markup language (HTML) document is provided. The method includes receiving a CI file including a set of instructions. The method also includes determining the current presentation time. The method further includes determining for each instruction or the set of instructions of the CI file if the instruction or the set of instructions is obsolete at the determined presentation time. The method includes parsing the remaining instructions that are determined not to be obsolete to update the HTML document.

### CROSS-REFERENCE TO RELATED APPLICATION(S) AND CLAIM OF PRIORITY

The present application claims priority to U.S. Provisional Patent Application Ser. No. 61/974,245, filed Apr. 2, 2014, entitled “METHOD AND APPARATUS FOR MARKING RELEVANT UPDATES TO HTML5.” The content of the above-identified patent document is incorporated herein by reference.

### TECHNICAL FIELD

The present disclosure relates generally to an apparatus and method for marking relevant updates to a HyperText-Markup-Language (HTML) 5 document, and more specifically, to parsing MPEG composition information (CI) update instructions.

### BACKGROUND

The MPEG CI specification describes how a client handles updates to a related HTML5 document. A CI document includes every incremental update to a document object model (DOM) initially created by an HTML 5 document. Upon receiving an update of a CI document, a client device parses all the updated instructions and only implements those instructions that are not obsolete. An instruction is obsolete when it is not relevant anymore at the current presentation time. Improvements to parsing updated instructions and implementing non-obsolete instructions are provided herein.

### SUMMARY

In a first example, a method for annotating instructions of Composition Information (CI) files to update a hypertext markup language (HTML) document is provided. The method includes receiving a CI file including a set of instructions. The method also includes determining the current presentation time. The method further includes determining for each instruction or the set of instructions of the CI file if the instruction or the set of instructions is obsolete at the determined presentation time. The method includes parsing the remaining instructions that are determined not to be obsolete to update the HTML document.

In a second example, an apparatus (e.g., mobile station) configured to annotate instructions of Composition Information (CI) files to update a hypertext markup language (HTML) document is provided. The apparatus includes a processing circuitry. The processing circuitry is configured to receive CI file including a set of instructions. The processing circuitry is also configured to determine the current presentation time. The processing circuitry is further configured to determine for each instruction or set of instructions of the CI file if the instruction or the set of instructions is obsolete at the determined presentation time. The processing circuitry is configured to parse the remaining instructions that are determined not to be obsolete to update the HTML document.

In a third example, a client device configured to annotate instructions of Composition Information (CI) files for to update hypertext markup language (HTML) document is provided. The client device includes a CI processing engine. The CI processing engine is configured to receive CI file including a set of instructions. The CI processing engine is also configured to determine the current presentation time. The CI processing engine is further configured to determine for each instruction or set of instructions of the CI file if the instruction or the set of instructions is obsolete at the determined presentation time. The CI processing engine is configured to parse the remaining instructions that are determined not to be obsolete to update the HTML document.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of a point-to-multipoint transmission system according to this disclosure;

FIG. 2 illustrates an example Composition Information (CI) layer according to this disclosure;

FIG. 3 is a high-level block diagram conceptually illustrating an example media presentation system according to this disclosure;

FIG. 4 is a flowchart illustrating an example operation according to this disclosure;

FIG. 5 is a flowchart illustrating an example operation according to this disclosure; and

FIG. 6 illustrates an example client device according to this disclosure.

### DETAILED DESCRIPTION

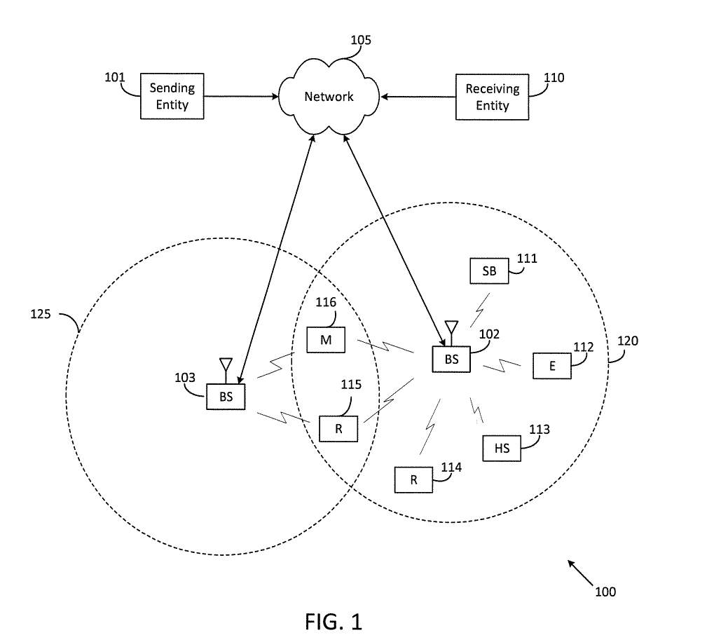

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

FIG. 1 illustrates an example of a point-to-multipoint transmission system 100 according to this disclosure. In the illustrated embodiment, the system 100 includes a sending entity 101, a network 105, receiving entities 110-116, wireless transmission points (e.g., an Evolved Node B (eNB), Node B), such as base station (BS) 102, base station (BS) 103, and other similar base stations or relay stations (not shown). Sending entity 101 is in communication with base station 102 and base station 103 via network 105 which can be, for example, the Internet, a media broadcast network, or IP-based communication system. Receiving entities 110-116 are in communication with sending entity 101 via network 105 and/or base stations 102 and 103.

Base station 102 provides wireless access to network 105 to a first plurality of receiving entities (e.g., user equipment, mobile phone, mobile station, subscriber station) within coverage area 120 of base station 102. The first plurality of receiving entities includes user equipment 111, which can be located in a small business (SB); user equipment 112, which can be located in an enterprise (E); user equipment 113, which can be located in a WiFi hotspot (HS); user equipment 114, which can be located in a first residence (R); user equipment 115, which can be located in a second residence (R); and user equipment 116, which can be a mobile device (M), such as a cell phone, a wireless communication enabled laptop, a wireless communication enabled PDA, a tablet computer, or the like.

Base station 103 provides wireless access to network 105 to a second plurality of user equipment within coverage area 125 of base station 103. The second plurality of user equipment includes user equipment 115 and user equipment 116. In an exemplary embodiment, base stations 101-103 can communicate with each other and with user equipment 111-116 using OFDM or OFDMA techniques including techniques for: presenting an HTML page as described in embodiments of the present disclosure.

While only six user equipment are depicted in FIG. 1, it is understood that system 100 can provide wireless broadband and network access to additional user equipment. It is noted that user equipment 115 and user equipment 116 are located on the edges of both coverage area 120 and coverage area 125. User equipment 115 and user equipment 116 each communicate with both base station 102 and base station 103 and can be said to be operating in handoff mode, as known to those of skill in the art.

User equipment 111-116 can access voice, data, video, video conferencing, and/or other broadband services via network 105. In an exemplary embodiment, one or more of user equipment 111-116 can be associated with an access point (AP) of a WiFi WLAN. User equipment 116 can be any of a number of mobile devices, including a wireless-enabled laptop computer, personal data assistant, notebook, handheld device, or other wireless-enabled device. User equipment 114 and 115 can be, for example, a wireless-enabled personal computer (PC), a laptop computer, a gateway, or another device.

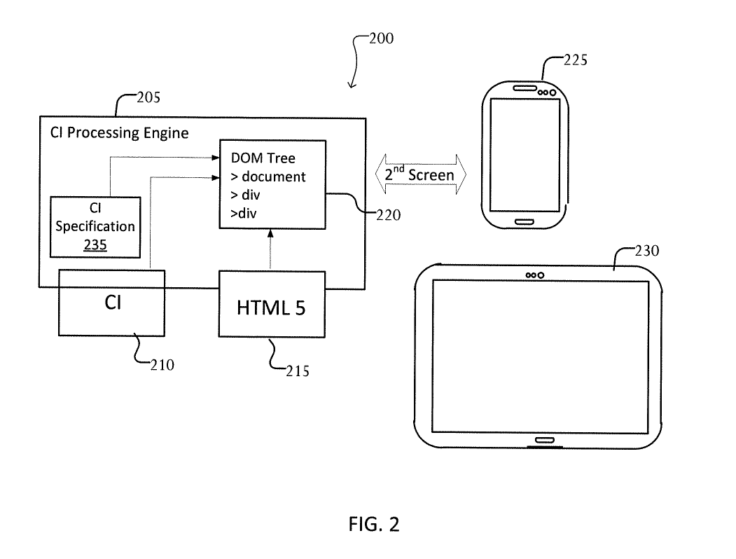

FIG. 2 illustrates an example Composition Information (CI) layer 200 according to this disclosure. The embodiment shown in FIG. 2 is for illustration only. Other embodiments of CI layer could be used without departing from the scope of the present disclosure.

The CI layer 200 is designed to provide temporal behavior of multimedia components on the HTML5 web page, for example, using declarative manner. In certain embodiments, the composition information is split over two separate files: a HTML 5 file 215 and a Composition Information (CI) file 210. A compatible HTML 5 file 215 provides the initial spatial layout and the place holder media elements, and a composition information file 210 contains timed instructions to control the media presentation.

In certain embodiments, temporal behavior of multimedia components on the web page of an HTML 5 file is provided by a CI file 210, where the web page can be referred by using its URI and the multimedia elements in the HTML5 file such as <video> and <audio> elements are referred by their IDs. In other words, the CI file 210 describes temporal behavior of multimedia component as a combination of temporal behavior of parts of multimedia data instead of temporal behavior of entire length of multimedia data to construct a multimedia component as a flexible combination of data from multiple data.

A CI processing engine 205, such as one found in a client device 225 or a client device 230, requests and receives a CI file 210 and an HTML 5 file 215 (as well as any other related files) from a sending entity (such as sending entity 101 of FIG. 1) and processes the composition information in order to render a presentation appropriately or as intended. The CI processing engine 205 parses HTML 5 files 215 into a document object model (DOM) tree 220 and stores the parsed HTML 5 files in memory. The CI processing engine 205 applies changes to the DOM tree 220 at specified times according to the information (such as instructions) available in the CI file 210. The CI processing engine 205 references nodes of the DOM tree 220 using identifiers or particular patterns (such as patterns provided through jQuery selectors).

The CI processing engine 205 also includes a CI specification 235. The CI specification 235 instructs the CI processing engine 205 how to handle newly received CI files 210 with additional information and the information of the previous CI file 210. The additional information updates related information of the previous CI file 210. A CI file 210 includes all incremental updated information to a DOM tree 220 initially created by the HTML 5 file 215. After (or in response to) receiving a new CI file 210 with additional information, for example to change or update a component of a presentation, the CI processing engine 205 parses all information of the new CI file 210 and only implements information that is not obsolete. Information is obsolete when it is not relevant anymore. Information is obsolete when the information has been overwritten by more recently updated information. For example, an original div element is obsolete when a position of a div element is changed with additional information of a new CI file 210. In this case, when content is presented, the original div element is not performed and the CI processing engine 205 sets the position of the div element to the position indicated by the additional information of the new CI file 210 so that the div element is performed at the new position. Furthermore, the same new CI file 210 may not have additional information related to a new position of a second div element. In this case, because the same new CI file 210 also contains the information of the previous CI file 210 assigning the second div element to its current position, after the CI processing engine 205 receives the new CI file 210, the second div element is still performed at its current position.

In order for the CI processing engine 205 to parse additional information of a new CI file 210, the CI processing engine 205 examines beginning attributes, attributes ending, and duration attributes of all information provided by the new CI file 210. Based on examining the beginning attributes, attributes ending, and duration attributes of all the information of the new CI file 210, the CI processing engine 205 identifies which information of the new CI file 210 is to be implemented. This parsing method can be inefficient slowing processing time and creating content presentation delays.

In an embodiment, in order to facilitate a more efficient parsing of information of a new CI file 210 so that only the information that is not obsolete is implemented, the CI processing engine 205 can assign an obsolete tag or attribute to all information of a CI file 210 that is determined to be obsolete. The CI specification 235 instructs the CI processing engine 205 to identify all information of a CI file 210 that is obsolete and attach an obsolete tag to that information. Furthermore, when receiving information of a new CI file 210, the CI specification 235 instructs the CI processing engine 205 to identify and disregard all information including updated information with an obsolete tag. By identifying and disregarding all information that is obsolete by identifying obsolete tags, the CI processing engine 205 reduces the amount of information of a new CI file 210 for parsing.

For example, a CI processing engine 205 receives an original or first CI file 210 with a first set of information identifying a first position of a div element. Subsequently, the CI processing engine receives a second CI file 210 with a second set of information updating the position of the div element to a second position. Later, the CI processing engine 205 receives a third CI file 210 with a third set of updated information updating the position of the div element to a third position. After changing the position of the div element at least once, the information of the first CI file identifying the first position of the div element is marked with an obsolete tag. Thus, when even later CI files 210 with updated information are received by the CI processing engine 205, the CI processing engine 205 can identify that the information positioning the div element in the first position was previously marked with an obsolete tag. Thus, the CI processing engine 205 does not have to further examine the div element marked obsolete reducing the time for parsing updated information of the CI file 205.

The CI processing engine 205, when receiving information of a new CI file 210, can compare the information of the new CI file 210 with the information of the previous CI file 210 to identify information with at least one change. Changes in information between consecutively received CI files can render the previous information that was changed obsolete. Because the new CI file 210 can contain the information of the previous CI file 210 as well as additional information, the CI processing engine 205 can mark the obsolete information on the new CI file 210 with an obsolete tag and discard the previous CI file 210. The CI processing engine can quickly identify and implement the additional information and the previous information which was not changed (i.e. all information that was not tagged with an obsolete tag) by identifying all information that does have an attached obsolete tag.

Subsequently, the CI processing engine 205 receives another CI file 210 with additional information and information of the previous CI file 205. The CI processing engine 205 can match all the information from the previous CI file 210 with an obsolete tag to the information of the other CI file 210 and attach an obsolete tag to same information of the other CI file 210. The CI processing engine 205 can again compare the information of the previous CI file 210 with information of the other CI file 210 to identify information with at least one change.

In an embodiment, in order to facilitate a more efficient parsing of information of a new CI file 210 so that only the information that is not obsolete is implemented, the CI processing engine 205 can assign a version tag or attribute to all information of a CI file 210 that is received by the CI processing engine 205. The CI specification 235 instructs the CI processing engine 205 to mark all information of a CI file 210 with a version tag. As a subsequent CI files 210 with the previous information and additional information are received by the CI processing engine 205, the CI processing engine 205 can provide a version tag with a number greater than the version tag of the previously received information (such as a version tag with an integer one greater than the previous version tag) for all additional information that changes information of the previous CI file 210.

Furthermore, when receiving information of a new CI file 210 and tagging additional information of the new CI file 210 with the most current version, the CI specification 235 instructs the CI processing engine 205 to identify and disregard all information with version tags indicating a version that is at least one version before the most recent version of the new CI file 210 rendering the older version information obsolete. By identifying and disregarding all updated information indicating a version that is at least one version before the most recent version of the new CI file 210, the CI processing engine 205 reduces the amount of information of the CI file 210 for parsing. It should be understood that as subsequent CI files 210 are received by the CI processing engine 205, some information is never changed or updated with subsequently received CI files 210. Thus, some information in a fifth received CI file 210 can have information with only two versions such that only the first version is disregarded and rendered obsolete while other information with a forth version has three versions that have been disregarded and rendered obsolete.

For example, a CI processing engine 205 receives an original or first CI file 210 with a first set of information identifying a first position of a div element. The CI processing engine 205 can tag every piece of information of the first set of information with a version “0” tag including the information identifying the first position of the div element. Subsequently, the CI processing engine receives a second CI file 210 with a second set of information updating the position of the div element to a second position. The CI processing engine 205 can tag every piece of additional information of the second set of information or information of the second set of information that changes information of the first set of information (some additional information can be new information that does not change information of the first set of information) with a version “1” tag including the information identifying the second position of the div element. Later, the CI processing engine receives a third CI file 210 with a third set of updated information updating the position of the div element to a third position. The CI processing engine 205 can tag every piece of additional information of the third set of information or information of the third set of information that changes information of the second set of information with a version “2” tag including the information identifying the third position of the div element.

By tagging each version of the information that changes the position of the div element, the information positioning the div element in the first position and the information positioning the div element in the second position are disregarded and rendered obsolete by the CI processing engine 205 because the versions “0” and “1” are at least one integer less than the latest version, version “2”. In some embodiments, the CI processing engine 205 can disregard the information positioning the div element in the first position, version “0”, but not the information positioning the div element in the second position, version “1” because the CI processing engine 205 only disregards information versions that are two integers less than the latest version, version “2.”

In an embodiment, in order to facilitate a more efficient parsing of information of a new CI file 210 so that only the information that is not obsolete is implemented, the CI processing engine 205 can assign a timestamp to all information of a CI file 210 that is received by the CI processing engine 205. The CI specification 235 instructs the CI processing engine 205 to mark all information of a CI file 210 with a time stamp. As subsequent CI files 210 with the previous information and additional information are received by the CI processing engine 205, the CI processing engine 205 can provide a timestamp that is a later time than the timestamp of the previously received information for all additional information that changes information of the previous CI file 210.

Furthermore, when receiving information of a new CI file 210 and time-stamping additional information of the new CI file 210 with the time that the new CI file 210 was received, the CI specification 235 instructs the CI processing engine 205 to identify and disregard all information with timestamps indicating a time that is earlier than the most recent timestamp of the new CI file 210 rendering the older information with older timestamps obsolete. By identifying and disregarding all updated information indicating a timestamp that is earlier than the timestamp of the most recent information of the new CI file 210, the CI processing engine 205 reduces the amount of information of the CI file 210 for parsing. It should be understood that as subsequent CI files 210 are received by the CI processing engine 205, some information is never changed or updated with subsequently received CI files 210. Thus, some information in a fifth received CI file 210 can have information with two timestamps associated with a first CI file 210 and a third CI file 210 such that only the information with the timestamp of the first CI file 210 is disregarded and rendered obsolete while the information with the timestamp of the third CI file 210 with the latest timestamp is implemented.

For example, a CI processing engine 205 receives an original or first CI file 210 with a first set of information identifying a first position of a div element. The CI processing engine 205 can tag every piece of information of the first set of information with a first timestamp including the information identifying the first position of the div element. Subsequently, the CI processing engine 205 receives a second CI file 210 with a second set of information updating the position of the div element to a second position. The CI processing engine 205 can tag every piece of additional information of the second set of information or information of the second set of information that changes information of the first set of information (some additional information can be new information that does not change information of the first set of information) with a second timestamp indicating a later time than the first timestamp including the information identifying the second position of the div element. Later, the CI processing engine receives a third CI file 210 with a third set of updated information updating the position of the div element to a third position. The CI processing engine 205 can tag every piece of additional information of the third set of information or information of the third set of information that changes information of the second set of information with a third timestamp indicating a later time than the second timestamp including the information identifying the third position of the div element. By time-stamping each iteration of the information that changes the position of the div element, the information positioning the div element in the first position and the information positioning the div element in the second position are disregarded and rendered obsolete by the CI processing engine 205 because the timestamps of those iterations are earlier than the information positioning the div element in the third position.

In an embodiment, in order to facilitate a more efficient parsing of information of a new CI file 210 so that only the information that is not obsolete is implemented, the CI processing engine 205 can assign an obsolete timer to all information of a CI file 210 that is received by the CI processing engine 205. The CI specification 235 instructs the CI processing engine 205 to assign all information of a CI file 210 with an obsolete timer. Accordingly, the CI processing engine 205 does not render information of a CI file 210 obsolete until the timer expires. Thus, for example information of a CI file 210 can be rendered obsolete before, during, or after a subsequent CI file 210 is received by the CI processing engine.

For example, a CI processing engine 205 receives an original or first CI file 210 with a first set of information identifying a first position of a div element. The CI processing engine 205 can assign one or more pieces of information of the first set of information with an obsolete timer including the information identifying the first position of the div element so that information is rendered or marked obsolete after a determine time from when the CI processor engine 205 receives the CI file 210. In an embodiment, the CI processing engine can assign obsolete timers of different lengths to different pieces of information of the same CI file 210 so that the different pieces of information of the same CI file 210 are rendered or marked obsolete at different times after being received.

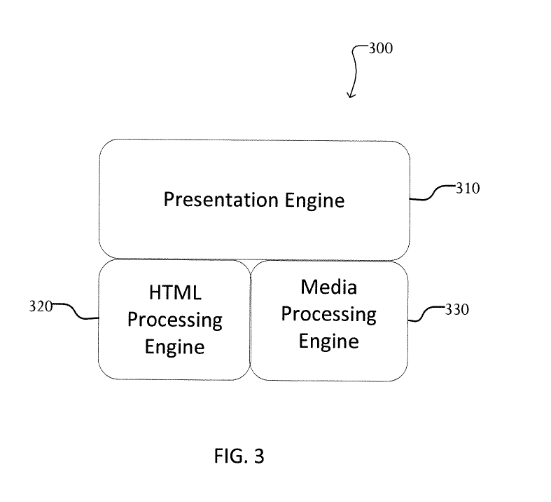

FIG. 3 is a high-level block diagram conceptually illustrating an example media presentation system 300 according to this disclosure. The embodiment in FIG. 3 is for illustration only. Other embodiments of media presentation system could be used without departing from the scope of the present disclosure.

The system include a presentation engine 310 at the upper level, and a HTML processing engine 320 and a media processing engine 330 at the lower level. The HTML 5 engine 320 processes HTML 5 web page and the media processing engine 330 processes the CI file 210 and the chunks listed in it. The presentation engine 310 merges the result of the media processing engine 330 with the result of HTML processing engine 310 and renders it together.

More particularly, the HTML 5 engine 320 parses the HTML 5 file into a Document Object Model (DOM) tree and stores in memory. The media processing engine 330 fetches the CI file 210 and the HTML5 file (and any other referenced files) and processes the CI information to control the presentation accordingly.

HTML processing engine 320 and media processing engine 330 can update their results at different time. In some examples, media processing engine 330 can continuously update the decoded media data while HTML processing engine 320 is parsing HTML 5 file and constructing rendering tree. For updating CI as described herein, the media processing engine 330 applies changes to the DOM at specified time according to the instructions that are available in the CI file 210. The DOM nodes/elements are referenced using their identifiers or possibly using a certain patterns (e.g. provided through jQuery selectors).

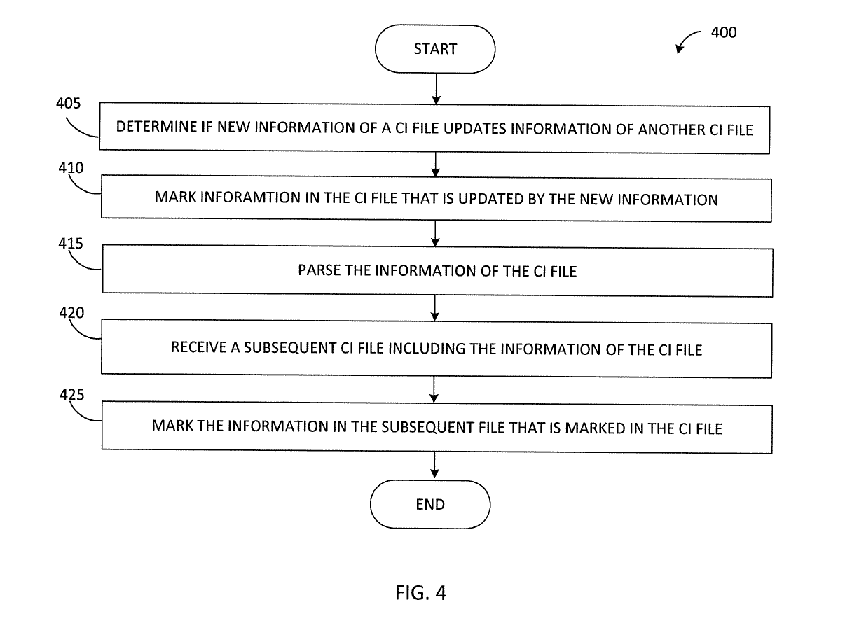

FIG. 4 is a flowchart 400 illustrating an example operation for annotating instructions of Composition Information (CI) files to update a hypertext markup language (HTML) document according to this disclosure. While the flowchart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The operation depicted in the example depicted is implemented by processing circuitry in a UE.

In block 405, a processor, such as a CI processing engine 205 of a client device, determines if a set of information provided only by a CI file 210 updates a previous set of information provided by the CI file 210 and a previous CI file 210. In block 410, the processor marks the previous set of information in the CI file 210 if the set of information provided only by the CI file 210 updates the previous set of information. In an embodiment, marking the previous set of information in the CI file 210 includes marking the previous set of information in the CI file 210 with an obsolete tag so that the HTML page is not presented based on the previous set of information. In another embodiment, marking the previous set of information in the CI file includes marking the previous set of information in the CI file 210 with a version tag so that the HTML page is not presented based on the previous set of information. In yet another embodiment, marking the previous set of information in the CI file 210 includes marking the previous set of information in the CI file 210 with a timestamp so that the HTML page is not presented based on the previous set of information.

In block 415, the processor parses the set of information provided only by the CI file 210 to present the HTML page. In block 420, the processor receives a subsequent CI file 210 comprising at least the set of information and the previous set of information. In block 425, the processor marks the previous set of information in the subsequent CI file 210 based on the marking of the previous set of information in the CI file 210.

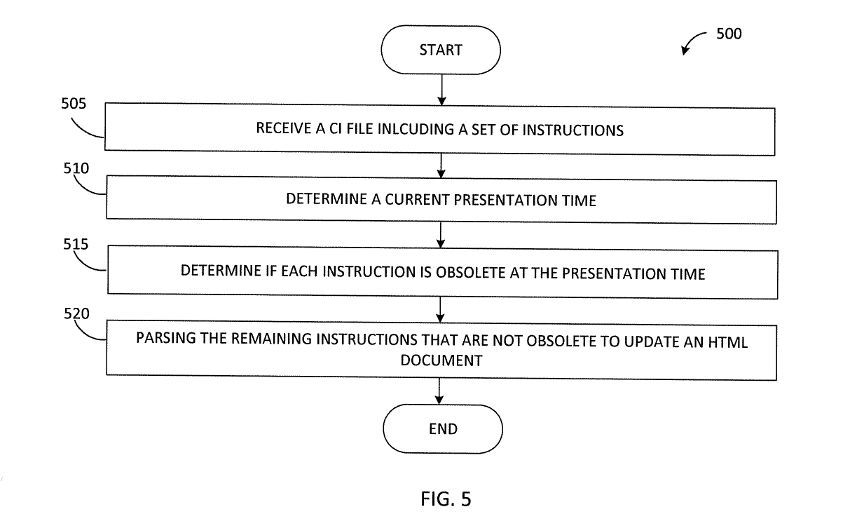

FIG. 5 is a flowchart 500 illustrating an example operation for annotating instructions of Composition Information (CI) files to update a hypertext markup language (HTML) document according to this disclosure. While the flowchart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The operation depicted in the example depicted is implemented by processing circuitry in a UE.

In block 505, a processor, such as a CI processing engine 205 of a client device, receives a CI file 210 including a set of instructions. In block 510, the CI processing engine 205 determines the current presentation time of the CI file 210. In block 515, the CI processing engine 205 determines for each instruction or for the set of instructions of the CI file 210 if the instruction or the set of instruction is obsolete at the current presentation time. In block 520, the CI processing engine 205 parses the remaining instructions that are determined not to be obsolete to update the HTML document.

In an embodiment, the CI processing engine 205 receives a subsequent CI file including at least a set of instructions and the previous set of instructions and determines that the previous set of instructions in the subsequent CI file is obsolete based on the set of instructions in the CI file. The CI processing engine 205 can mark the previous set of information in the CI file with at least one of an obsolete tag, a version tag, or a timestamp so that the HTML page is not presented based on the previous set of information.

In an embodiment, CI processing engine 205 receives the previous set of information provided by the previous CI file and assigns an obsolete timer to the previous set of information. The CI processing engine subsequently receives the set of information provided by the CI file after receiving the previous set of information. The CI processing engine 205 also disregards the obsolete instruction or set of instructions of the CI file if the instruction or the set of instructions is obsolete at the determined presentation time.

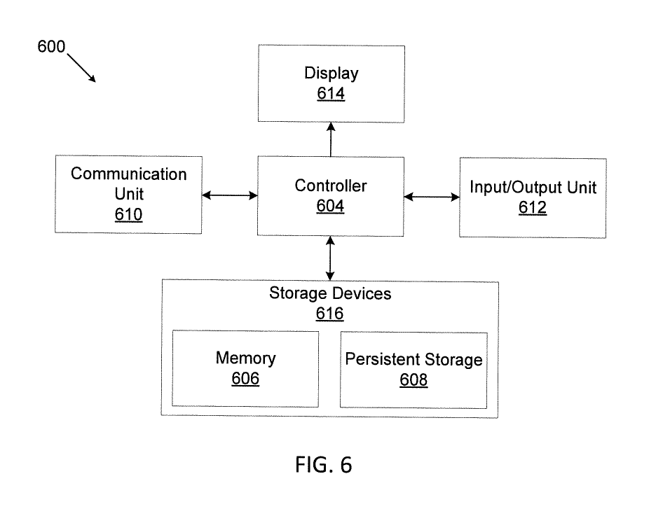

FIG. 6 illustrates an example client device 600 according to this disclosure. In this example, the client device 600 includes a controller 604, a memory 606, a persistent storage 608, a communication unit 610, an input/output (I/O) unit 612, and a display 614. In these illustrative examples, client device 600 is an example of one implementation of the sending entity 101 and/or the receiving entities 110-116 in FIG. 1.

Controller 604 is any device, system, or part thereof that controls at least one operation. Such a device can be implemented in hardware, firmware, or software, or some combination of at least two of the same. For example, the controller 604 can include a hardware processing unit and/or software program configured to control operations of the client device 600. For example, controller 604 processes instructions for software that can be loaded into memory 606. Controller 604 can include a number of processors, a multi-processor core, or some other type of processor, depending on the particular implementation. Further, controller 604 can be implemented using a number of heterogeneous processor systems in which a main processor is present with secondary processors on a single chip. As another illustrative example, controller 604 can include a symmetric multi-processor system containing multiple processors of the same type.

Memory 606 and persistent storage 608 are examples of storage devices 516. A storage device is any piece of hardware that is capable of storing information, such as, for example, without limitation, data, program code in functional form, and/or other suitable information either on a temporary basis and/or a permanent basis. Memory 606, in these examples, can be, for example, a random access memory or any other suitable volatile or non-volatile storage device. For example, persistent storage 608 can contain one or more components or devices. Persistent storage 608 can be a hard drive, a flash memory, an optical disk, or some combination of the above. The media used by persistent storage 608 also can be removable. For example, a removable hard drive can be used for persistent storage 608.

Communication unit 610 provides for communications with other data processing systems or devices. In these examples, communication unit 610 can include a wireless (cellular, WiFi, etc.) transmitter, receiver and/or transmitter, a network interface card, and/or any other suitable hardware for sending and/or receiving communications over a physical or wireless communications medium. Communication unit 610 can provide communications through the use of either or both physical and wireless communications links.

Input/output unit 612 allows for input and output of data with other devices that can be connected to or a part of the client device 600. For example, input/output unit 612 can include a touch panel to receive touch user inputs, a microphone to receive audio inputs, a speaker to provide audio outputs, and/or a motor to provide haptic outputs. Input/output unit 612 is one example of a user interface for providing and delivering media data (e.g., audio data) to a user of the client device 600. In another example, input/output unit 612 can provide a connection for user input through a keyboard, a mouse, external speaker, external microphone, and/or some other suitable input/output device. Further, input/output unit 612 can send output to a printer. Display 614 provides a mechanism to display information to a user and is one example of a user interface for providing and delivering media data (e.g., image and/or video data) to a user of the client device 600.

Program code for an operating system, disclosures, or other programs can be located in storage devices 616, which are in communication with the controller 604. In some embodiments, the program code is in a functional form on the persistent storage 608. These instructions can be loaded into memory 606 for processing by controller 604. The processes of the different embodiments can be performed by controller 604 using computer-implemented instructions, which can be located in memory 606. For example, controller 604 can perform processes for one or more of the modules and/or devices described above.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for annotating instructions of Composition Information (CI) files to update a hypertext markup language (HTML) document, comprising:
receiving a CI file including a set of instructions;
determining the current presentation time;
determining for each instruction or the set of instructions of the CI file if the instruction or the set of instructions is obsolete at the determined presentation time; and
parsing the remaining instructions that are determined not to be obsolete to update the HTML document.

2. The method of claim 1, further comprising:
receiving a subsequent CI file comprising at least a set of instruction and the previous set of instructions; and
determining that the previous set of instructions in the subsequent CI file is obsolete based on the set of instructions in the CI file.

3. The method of claim 1, further comprising marking the previous set of information in the CI file with an obsolete tag so that the HTML page is not presented based on the previous set of information.

4. The method of claim 1, further comprising marking the previous set of information in the CI file with a version tag so that the HTML page is not presented based on the previous set of information.

5. The method of claim 1, further comprising marking the previous set of information in the CI file with a timestamp so that the HTML page is not presented based on the previous set of information.

6. The method of claim 1, further comprising receiving the previous set of information provided by the previous CI file and assigning an obsolete timer to the previous set of information; and
receiving the set of information provided by the CI file after receiving the previous set of information.

7. The method of claim 6, further comprising marking at least some of the previous set of information as obsolete if the obsolete timer expires before receiving the set of information provided by the CI file.

8. The method of claim 1, further comprising if the instruction or the set of instructions is obsolete at the determined presentation time disregarding the obsolete instruction or set of instructions of the CI file.

9. An apparatus configured to annotate instructions of Composition Information (CI) files to update a hypertext markup language (HTML) document, the apparatus comprising a processing circuitry configured to:
receive CI file including a set of instructions;
determine the current presentation time;
determine for each instruction or set of instructions of the CI file if the instruction or the set of instructions is obsolete at the determined presentation time; and
parse the remaining instructions that are determined not to be obsolete to update the HTML document.

10. The apparatus of claim 9, wherein the processing circuitry is configured to:
receive a subsequent CI file comprising at least a set of instruction and the previous set of instructions; and
determine that the previous set of instructions in the subsequent CI file is obsolete based on the set of instructions in the CI file.

11. The apparatus of claim 9, wherein the processing circuitry is configured to mark the previous set of information in the CI file with an obsolete tag so that the HTML page is not presented based on the previous set of information.

12. The apparatus of claim 9, wherein the processing circuitry is configured to mark the previous set of information in the CI file with a version tag so that the HTML page is not presented based on the previous set of information.

13. The apparatus of claim 9, wherein the processing circuitry is configured to mark the previous set of information in the CI file with a timestamp so that the HTML page is not presented based on the previous set of information.

14. The apparatus of claim 9, wherein the processing circuitry is configured to:
receive the previous set of information provided by the previous CI file and assigning and obsolete timer to the previous set of information; and
receive the set of information provided by the CI file after receiving the previous set of information.

15. The apparatus of claim 14, wherein the processing circuitry is configured to mark the previous set of information in the CI file by marking at least some of the previous set of information as obsolete if the obsolete timer expires before receiving the set of information provided by the CI file.

16. The apparatus of claim 9, wherein the processing circuitry is configured to if the instruction or the set of instructions is obsolete at the determined presentation time disregard the obsolete instruction or set of instructions of the CI file.

17. A client device configured to annotate instructions of Composition Information (CI) files for to update hypertext markup language (HTML) document, the client device comprising a CI processing engine configured to:
receive CI file including a set of instructions;
determine the current presentation time;
determine for each instruction or set of instructions of the CI file if the instruction or the set of instructions is obsolete at the determined presentation time; and
parse the remaining instructions that are determined not to be obsolete to update the HTML document.

18. The client device of claim 17, wherein the processing engine is configured to:
receive a subsequent CI file comprising at least a set of instruction and the previous set of instructions; and
determine that the previous set of instructions in the subsequent CI file is obsolete based on the set of instructions in the CI file.

19. The client device of claim 17, wherein the processing engine is configured to mark the previous set of information in the CI file with an obsolete tag so that the HTML page is not presented based on the previous set of information.

20. The client device of claim 17, wherein the processing engine is configured to mark the previous set of information in the CI file with an obsolete tag so that the HTML page is not presented based on the previous set of information.
